(19) United States
(12) Patent Application Publication
(10) Pub. No.: US 2026/0340042 A1
(43) Pub. Date: Oct. 29, 2026

(54) ACCESS-RESTRICTED INPUT DATA RETRIEVAL FOR RAG ARCHITECTURE

(71) Applicant: The Toronto-Dominion Bank, Toronto (CA)

(72) Inventors: Mohammad Ghasemi Damavandi, Toronto (CA); Javad Kazemian, London (CA); John Jong-Suk Lee, Toronto (CA)

(73) Assignee: The Toronto-Dominion Bank, Toronto, ON (CA)

(21) Appl. No.: 19/187,664

(22) Filed: Apr. 23, 2025

(51) Int. Cl. G06F 16/9035; G06F 16/2452

(52) U.S. Cl. CPC G06F 16/9035; G06F 16/24522

(57) ABSTRACT

An example operation may include at least one of receiving a natural language query associated with a profile, determining access privileges of the profile to a database, filtering documents within the database to remove document content that does not match the access privileges, retrieving a subset of the filtered documents based on a comparison of the filtered documents to the natural language query in vector space, generating a response to the natural language query based on the retrieved subset of filtered documents, and sending the response to a software application. The example operation may further include an AI agent performing an action related to the response.

### BACKGROUND

Retrieval-Augmented Generation (RAG) is an artificial intelligence (AI) framework that combines, for example, large language models (LLMs) with information retrieval systems. RAG can be used to improve the accuracy and relevance of responses by ensuring more up-to-date and relevant information is used. For example, the RAG system may receive a natural language input, and in response, may generate a natural language output. The response may be bolstered by, or informed by, a series of documents that are “retrieved” by the RAG framework and which are highly related to the natural language input enabling the RAG framework to generate an accurate natural language response.

### SUMMARY

One example embodiment provides an apparatus that includes a memory and at least one processor communicatively coupled to the memory, wherein the at least one processor may at least one of receive a natural language query associated with a profile, determine access privileges of the profile to a database, filter documents within the database to remove document content that does not match the access privileges, retrieve a subset of the filtered documents based on a comparison of the filtered documents to the natural language query in vector space, generate a response to the natural language query based on the retrieved subset of filtered documents, and send the response to a software application.

Another example embodiment provides a method that includes at least one of receiving a natural language query associated with a profile, determining access privileges of the profile to a database, filtering documents within the database to remove document content that does not match the access privileges, retrieving a subset of the filtered documents based on a comparison of the filtered documents to the natural language query in vector space, generating a response to the natural language query based on the retrieved subset of filtered documents, and sending the response to a software application.

A further example embodiment provides a computer readable storage medium comprising instructions, that when read by a processor, cause the processor to perform at least one of receiving a natural language query associated with a profile, determining access privileges of the profile to a database, filtering documents within the database to remove document content that does not match the access privileges, retrieving a subset of the filtered documents based on a comparison of the filtered documents to the natural language query in vector space, generating a response to the natural language query based on the retrieved subset of filtered documents, and sending the response to a software application.

### BRIEF DESCRIPTION OF DRAWINGS

FIG. 1A is a diagram illustrating an operating environment of a software service, according to examples and features of the instant solution.

FIG. 1B is a diagram illustrating a RAG architecture according to the examples and features of the instant solution.

FIG. 2A is a system diagram illustrating integration of an AI model into any decision point, according to the examples and features of the instant solution.

FIG. 2B is a diagram illustrating a process for developing an AI model that supports AI-assisted computer decision points, according to the examples and features of the instant solution.

FIG. 2C is a diagram illustrating a process for utilizing an AI model that supports AI-assisted computer decision points according to examples and features of the instant solution.

FIG. 2D is a system diagram illustrating a chatbot service that utilizes an AI model.

FIG. 3 is a system diagram illustrating an operating environment for a RAG-based framework according to the examples and features of the instant solution.

FIGS. 4A-4C are diagrams illustrating a process of a RAG architecture that uses filters documents during retrieval based on access credentials according to the examples and features of the instant solution.

FIG. 5 is a diagram illustrating a process of partially redacting vector content according to the examples and features of the instant solution.

FIG. 6 is a diagram illustrating a process of modifying filtering settings of the retriever described herein according to the examples and features of the instant solution.

FIG. 7A is a diagram illustrating a method for recommending an AI model according to the examples and features of the instant solution.

FIG. 7B is a diagram illustrating an additional method for recommending an AI model according to the examples and features of the instant solution.

FIG. 8 is a system diagram illustrating a computing environment according to the instant solution's example features, structures, or characteristics.

### DETAILED DESCRIPTION

A retrieval-augmented generative (RAG) software architecture combines information retrieval systems with AI models, e.g., LLMs. A traditional use case for a RAG software architecture is within a chat application. In this case, the RAG architecture may be responsible for conducting a conversation with an end user. The end user may query the RAG architecture with natural language input (e.g., questions, etc.) which is then converted into a vector and used to generate a response.

For example, a retriever within the RAG architecture may identify document content (that's been stored as vectors) within a vector database which are related to the natural language input using a similarity analysis in vector space. The retriever may retrieve the identified document content and transfer the document content with the natural language query to the LLM. In response, the LLM generates a response to the natural language input using the identified document content. The use of the additional document content makes the responses more relevant and more specific to the needs of the end user in comparison to a generic AI model that does not use RAG.

In the example embodiments, the vector database may include different groups, tiers, or pools of members. Each group of members may include access to a different subset of documents/vectors stored within the vector database. For example, a first user may have a management role, and may have greater access to document content in the vector database than a second user that is new to the organization. As another example, a third user may be an administrator with greater access to document content than both the first and second users.

The access credentials for each user, group, etc., may be contained within a database that is managed by the RAG architecture. When an input is received, the system can identify a profile, a payment card, a user identifier, a device identifier, or the like, which may be used to identify the access credentials. The system may then filter the vector database using the access credentials. After the vector database is filtered, the system may then identify relevant document content thereby ensuring that the only documents that are retrieved by the RA G architecture are authorized for viewing by the user.

Some of the benefits of the filtering RAG architecture described herein include ensuring the security of the data used by the LLM when generating a response. In particular, the RAG architecture can generate responses using only document content that the user is authorized to view/access. This ensures that the response generated by the LLM does not provide or otherwise disclose sensitive information that the user is not supposed to be exposed to because the LLM only considers document content that the user is authorized to view. Furthermore, the architecture can significantly reduce the amount of content that is processed by the AI model during response generation by removing, redacting, or otherwise ignoring document content that a user does not have authority to access. As such, the AI model may execute faster and use less processing bandwidth and storage resources.

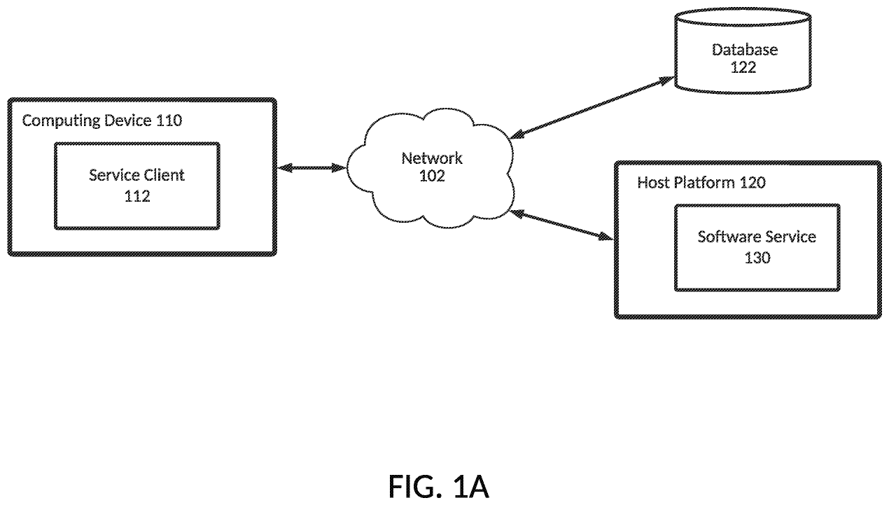

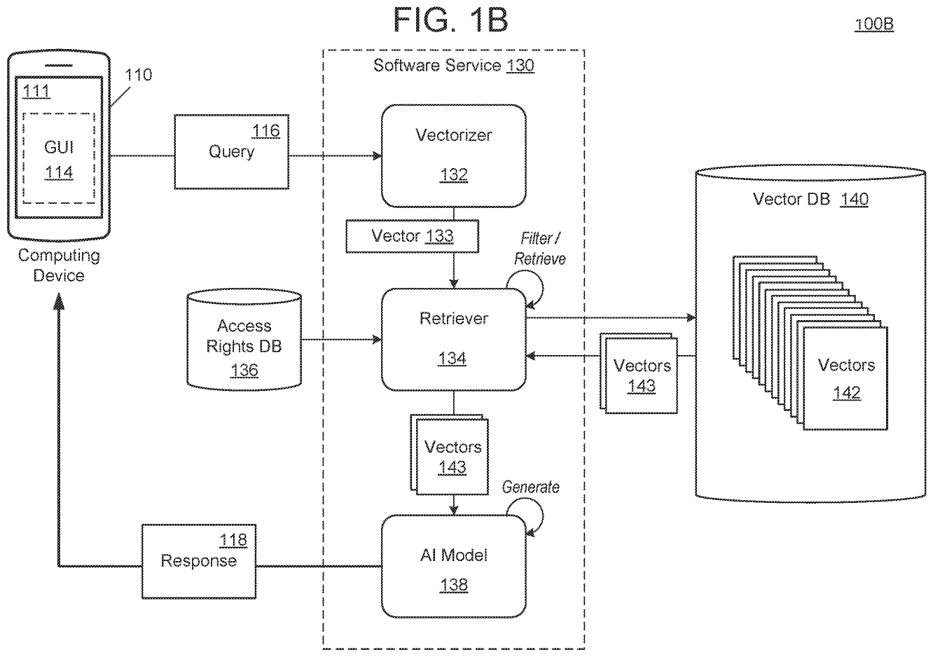

FIG. 1A illustrates an operating environment 100A of the instant solution. As shown, at least one computing device 110, and a host platform 120 communicate via a network 102. The host platform 120 may host a software service 130. The software service 130 may communicate with at least one database 122 through a network 102 during the course of service execution. Each computing device 110 may host a service client 112, which communicates with the corresponding software service 130.

The computing device 110 may be a mobile phone, tablet, laptop computer, desktop computer, smartwatch, vehicle infotainment system, or any computing device including a processor and memory. The host platform 120 may include a single physical server, multiple physical servers, a cloud hosting environment, or a hybrid hosting environment in which some components of the host platform 120 are “on-premise” while others are cloud-hosted. The network 102 is a computer network and may include at least one interconnected computer network. For example, network 102 may be or may include an Ethernet network, an asynchronous transfer mode (ATM) network, a wireless network, a telecommunications network or the like.

The software service 130 provides the service logic. It may provide at least one Application Programming Interface (API) for communicating with at least one service client 112. A “thick” user interface client that runs on the computing device 110 may utilize the APIs to communicate with the software service 130. Further, the software service 130 may provide hosted User Interfaces (Uls) that can be accessed through browser-based software on the computing device 110.

The service client 112 can enable service access for end users and may come in a variety of forms including, but not limited to, a mobile device application (“app”) or a web portal accessed via a browser on the computing device 110 such as a laptop or desktop computer.

Detailed descriptions of the architecture and operation of the software service 130 in the instant solution are further described and depicted herein. For example, the software service 130 may include a response generation framework with a retrieval augmented generation (RAG) architecture.

FIG. 1B illustrates a process 100B of retrieving document content using the RAG architecture according to the examples and features of the instant solution. Referring to FIG. 1B, a user may submit a query 116 (e.g., a natural language input, etc.) to the software service 130 by inputting text or speaking into the computing device 110. For example, the user may submit the query 116 by pressing buttons or otherwise inputting text into a graphical user interface (GUI) 114 that is depicted on a display device 111 of the computing device 110. As another example, a software application or system (not shown) may submit a query (such as a machine-readable query) to the software service 130 with a request for content.

As an example, the GUI 114 may include a chat window or other service which enables the user of the computing device 110 to submit questions and receive responses from the software service 130. In some embodiments, the software service 130 may receive the questions and generate a response. The process may continue with the user asking questions and the software service 130 providing more and more detailed responses as the content within the GUI 114 continues to increase.

The query 116 may be converted into a vector 133 by a vectorizer 132 of the software service 130. The vector 133 may be generated by converting the natural language input into an embedding within vector space. A retriever 134 may receive the vector 133 from the vectorizer 132, and use it to perform a similarity analysis against vectors 142 stored in a vector database 140 for similar vector content stored in the vector database 140. The vectors 142 in the vector database 140 may contain vectorized document content from an organization. However, rather than perform a traditional retrieval operation, the retriever 134 may filter the vectors 142 within the vector database 140 to remove vectors and/or vector content that is not authorized for view by the user of the computing device 110.

For example, the retriever 134 may receive the identifier of the user/device from the query 116 and identify access privileges/rights of the user/device from an access rights database 136. The retriever 134 may use the access privileges to remove document/vector content from the vectors 142 and retrieve a subset of filtered vectors 143. The subset of filtered vectors 143 may be transferred to an AI model 138, such as a large language model or the like, which can generate a response 118 (eg., a natural language response, etc.) to the query 116 and send the response 118 to the computing device 110 where it is output on the GUI 114, for example, via a chatbot or the like.

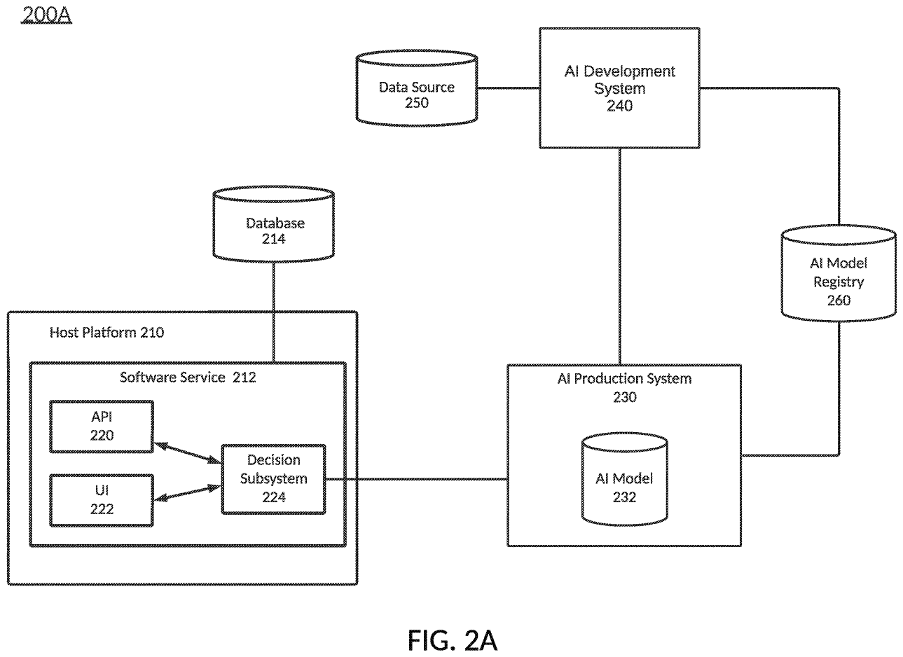

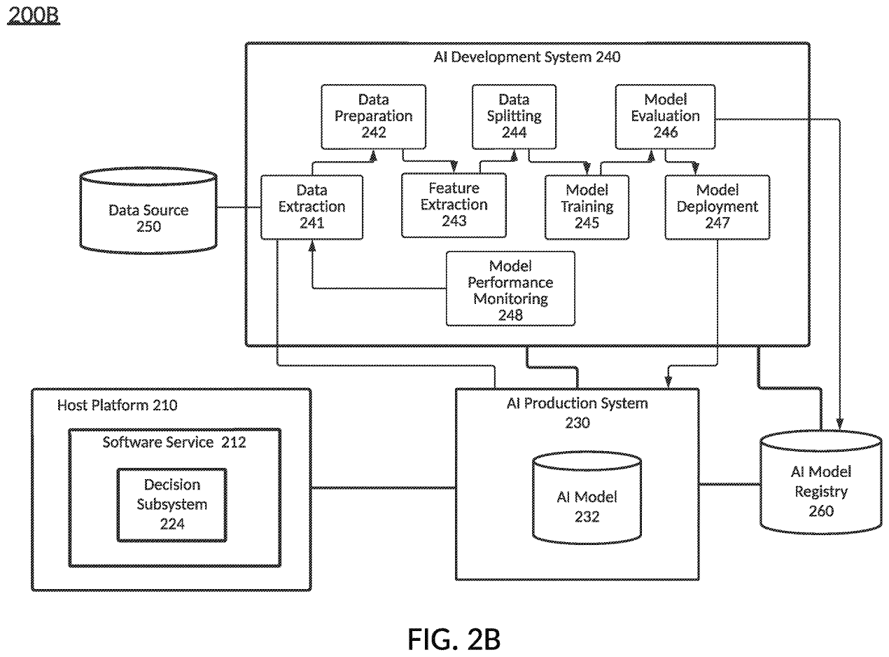

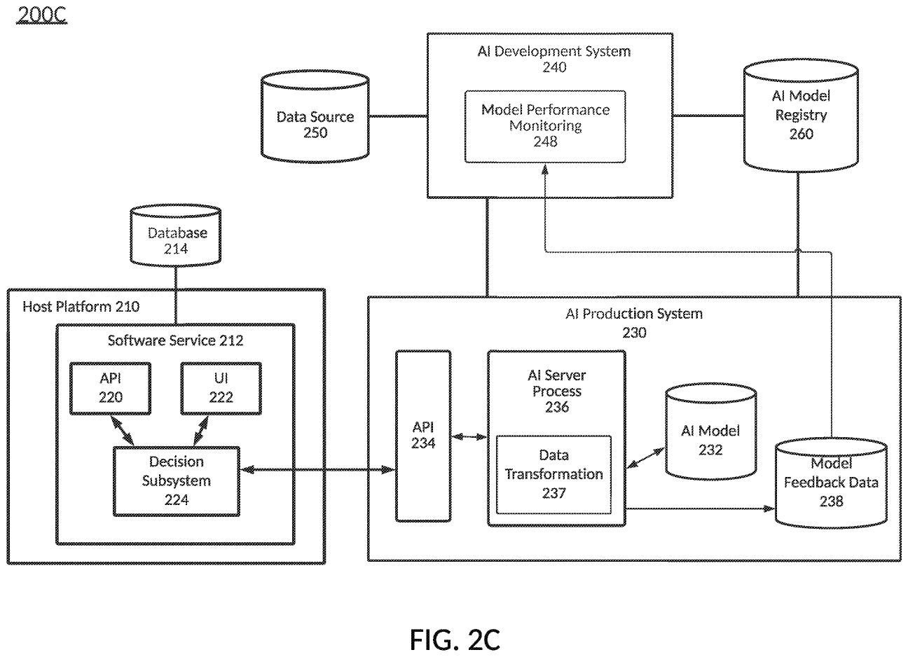

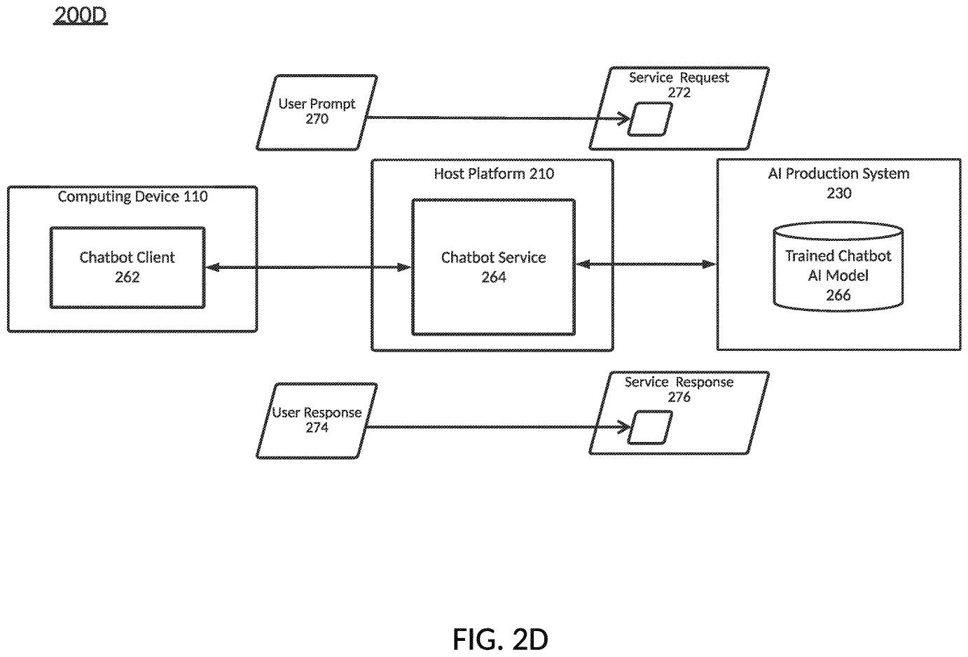

FIG. 2A illustrates an artificial intelligence (AI) network diagram 200A that supports AI-assisted decision points in a software service executing on a computer. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Software service 212, executing on host platform 210 may provide at least one API 220 that enable interaction with other software components via a set of data definitions and protocols. In some examples and features of the instant solution, the at least one API provided may employ Simple Object Access Protocol (SOAP), Remote Procedure Calls (RPC), and Representational State Transfer (REST) techniques. In some examples and features of the instant solution, the plurality of A Pls 220 send data to at least one decision subsystem 224 of the software service 212 to assist in decision-making. In some examples and features of the instant solution, the software service 212 stores data included in API requests or data generated during processing the API requests into at least one database 214. In some examples and features of the instant solution, software service 212 is a chatbot service.

Software service 212 may provide at least one user interface (UI) 222, such as a server-side hosted graphical user interface (GUI). In some examples and features of the instant solution, the Uls 222 provided employ template-based frameworks, component-based frameworks, etc. In some examples and features of the instant solution, these UIs 222 send data to at least one decision subsystem 224 of the software service 212 to assist with decision-making. In some examples and features of the instant solution, the software service 212 stores data included in UI requests or data generated during processing the UI requests into at least one database 214.

Software service 212 may include at least one decision subsystem 224 that drive a decision-making process of the software service 212. In some examples and features of the instant solution, the decision subsystems 224 receive data from at least one API 220 as input into the decision-making process. In some examples and features of the instant solution, a decision subsystem 224 may receive data from at least one UI 222 as input to the decision-making process. A decision subsystem 224 may gather service configuration or historical execution data from at least one database 214 to aid in the decision-making process. A decision subsystem 224 may provide feedback to an API 220 or a UI 222.

An AI production system 230 may be used by a decision subsystem 224 in a software service 212 to assist in its decision-making process. The AI production system 230 includes at least one AI model 232 that is executed to generate a response, such as, but not limited to, a prediction, a categorization, a UI prompt, etc. In some examples and features of the instant solution, the AI model 232 has been trained to provide chatbot responses. In some examples and features of the instant solution, an AI production system 230 is hosted on a server. In some examples and features of the instant solution, the AI production system 230 is cloud-hosted. In some examples and features of the instant solution, the AI production system 230 is deployed in a distributed multi-node architecture.

An AI development system 240 creates at least one AI model 232. In some examples and features of the instant solution, the AI development system 240 utilizes data from at least one data source 250 to develop and train at least one AI model 232. The data sources 250 may be local or third-party data sources. Further, the data provided by the data sources may be real-world or synthetic. In some examples and features of the instant solution, the AI development system 240 utilizes feedback data from at least one AI production system 230 for new model development and/or existing model re-training. In some examples and features of the instant solution, the AI development system 240 resides and executes on a server. In some examples and features of the instant solution, the AI development system 240 is cloud hosted. In some examples and features of the instant solution, the AI development system 240 is deployed in a distributed multi-node architecture. In some examples and features of the instant solution, the AI development system 240 utilizes a distributed data pipeline/analytics engine.

Once an AI model 232 has been trained and validated in the AI development system 240, it may be stored in an AI model registry 260 for retrieval by either the AI development system 240 or by at least one AI production system 230. The AI model registry 260 resides in a dedicated server in one example of the instant solution. In some examples and features of the instant solution, the AI model registry 260 is cloud-hosted. In some examples and features of the instant solution, the AI model registry 260 resides in the AI production system 230. In some examples and features of the instant solution, the AI model registry 260 is a distributed database.

FIG. 2B illustrates a process 200B for developing at least one AI model that support AI-assisted decision points. An AI development system 240 executes steps to develop an AI model 232 that begins with data extraction 241, in which data is loaded and ingested from at least one data source 250. In some examples and features of the instant solution, historical model feedback data is extracted from at least one AI production system 230.

Once the data has been extracted during data extraction 241, it undergoes data preparation 242 for model training. In some examples and features of the instant solution, this step involves statistical testing of the data to see how well it reflects real-world events, its distribution, the variety of data in the dataset, etc., and the results of this statistical testing may lead to at least one data transformation being employed to normalize at least one value in the dataset. In some examples and features of the instant solution, data deemed to be noisy is cleaned. A noisy dataset includes values that do not contribute to the training, such as, but not limited to, null and long string values. Data preparation 242 may be a manual process or an automated process using at least one of the elements and/or functions described and/or depicted herein.

Features of the data are identified and extracted during the feature extraction step 243. In some examples and features of the instant solution, a feature of the data is internal to the prepared data from the data preparation step 242. In some examples and features of the instant solution, a feature of the data requires a piece of prepared data from the data preparation step 242 to be enriched by data from another data source to be useful in developing the AI model 232. In some examples and features of the instant solution, identifying features may be a manual process or an automated process using at least one of the elements and/or functions described and/or depicted herein. Once the features have been identified, the values of the features are collected into a dataset that will be used to develop the AI model 232.

The dataset output from the feature extraction step 243 is split 244 into a training and validation data set. The training data set is used to train the AI model 232, and the validation data set is used to evaluate the performance of the AI model 232 on unseen data.

The AI model 232 is trained and tuned 245 using the training data set from the data splitting step 244. In this step, the training data set is provided to an AI algorithm and an initial set of algorithm parameters. The performance of the AI model 232 is then tested within the AI development system 240 utilizing the validation data set from step 244. These steps may be repeated with adjustments to at least one algorithm parameter until the model's performance is acceptable based on various goals and/or results.

The AI model 232 is evaluated 246 in a staging environment (not shown) that resembles the target AI production system 230. This evaluation uses a validation dataset to ensure the performance in an AI production system 230 matches or exceeds expectations. In some examples and features of the instant solution, the validation dataset from step 244 is used. In some examples and features of the instant solution, at least one unseen validation dataset is used. In some examples and features of the instant solution, the staging environment is part of the AI development system 240, and the staging environment is managed separately from the AI development system 240. Once the AI model 232 has been validated, it is stored in an AI model registry 260, where it can be retrieved for deployment and future updates. In some examples and features of the instant solution, the model evaluation step 246 may be a manual process or an automated process using at least one of the elements and/or functions described and/or depicted herein.

In some examples and features of the instant solution, the AI development system includes a user interface (not shown). The user interface may be used to manage the development system infrastructure, the steps 241-248 within the development system, the interim data transmitted between the various steps 241-248, and the data sources 250.

Once an AI model 232 has been validated and published to an AI model registry 260, it may be deployed during the model deployment step 247 to at least one AI production system 230. In some examples and features of the instant solution, the performance of deployed AI model 232 is monitored 248 by the AI development system 240. In some examples and features of the instant solution, AI model 232 feedback data is provided by the AI production system 230 to enable model performance monitoring 248, and the AI development system 240 periodically requests feedback data for model performance monitoring 248, which includes at least one trigger that results in the AI model 232 being updated by repeating steps 241-248 with updated data from at least one data source 250.

FIG. 2C illustrates a process 200C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 2C, an AI production system 230 may be used by a decision subsystem 224 in software service 212 to assist in its decision-making process. The AI production system 230 provides an API 234, executed by an AI server process 236 through which requests can be made. In some examples and features of the instant solution, a request may include an AI model 232 identifier to be executed based on the type of request. In some examples and features of the instant solution, a data payload (e.g., to be input to the AI model during execution) is included in the request. The data payload may include API 220 data from software service 212, UI 222 data from software service 212 or data from other software service 212 subsystems (not shown).

Upon receiving the API 234 request, the AI server process 236 may transform 237 the data payload or portions of the data payload to be valid feature values in an AI model 232. Data transformation 237 may include, but is not limited to, combining data values, normalizing data values, and enriching the incoming data with data from other data sources 250. Once the data transformation occurs, the AI server process 236 executes the appropriate AI model 232 using the transformed input data. Upon receiving the execution result, the AI server process 236 responds to the API requester, which is a decision subsystem 224 of software service 212. In some examples and features of the instant solution, the response may result in an update to a UI 222 in software service 212. In some examples and features of the instant solution, the response includes a request identifier that can be used later by the software service 212 to provide feedback on the performance of the AI model 232. In some examples and features of the instant solution, a model feedback record may be added into a model feedback data 238 by the AI server process 236.

In some examples and features of the instant solution, the API 234 includes an interface to provide AI model 232 feedback after an AI model 232 execution response has been processed. This mechanism enables the requester to provide feedback on the accuracy of the AI model 232 results. In some examples and features of the instant solution, the feedback interface includes the identifier of the initial request so that it can be used to associate the feedback with the request. Upon receiving a call into the feedback interface of the API 234, the AI server process 236 creates and adds a model feedback record into the model feedback data 238 which holds historical model feedback records. In some examples and features of the instant solution, the records in this model feedback data 238 are provided to model performance monitoring 248 in the AI development system 240. This model feedback data is streamed to the AI development system 240 or may be provided upon request. In some examples and features of the instant solution, the model feedback records in the model feedback data 238 are used as an input for retraining the AI model 232.

M odel retraining involves repeating steps 241-246 using the current data in the data source 250 along with the model feedback data 238. In some examples and features of the instant solution, the AI model 232 is retrained periodically as a matter business process in order to consider the latest data and/or retrained based on a trigger, such as, but not limited to, a recent model accuracy falling below a pre-determined threshold. In some examples and features of the instant solution, the model feedback data 238 is used as an input to determine the recent model accuracy.

In some examples and features of the instant solution, the AI production system 230 includes a user interface (not shown). The user interface may be used to manage the production system infrastructure, the components of the production system 230-238, and the operation of the AI production system and its components.

FIG. 2D illustrates a process 200D of a chatbot service that utilizes an AI model. Referring to FIG. 2D, a computing device 110 may host a chatbot client 262 which interworks with a chatbot service 264 executing on a host platform 120. Further, the chatbot service 264 utilizes a trained chatbot AI model 266 that is resident on an AI production system 230. In some examples and features of the instant solution, the chatbot client 262 is an example of a service client. In some examples and features of the instant solution, the chatbot service 264 is an example of software service 212 which includes an API 220, a UI 222 and at least one decision subsystem 224. In some examples and features of the instant solution, the trained chatbot AI model 266 is an example of AI model 232 which is hosted on an AI production system 230. In some examples and features of the instant solution, the AI production system 230 includes the internal architectural elements depicted in FIG. 2C.

The chatbot client 262 accepts and captures a user prompt 270 which it sends to the chatbot service 264. Upon receiving the user prompt 270, the chatbot service 264 builds a service request 272 that includes the user prompt 270. In some examples and features of the instant solution, the service request 272 may include a target AI model identifier, such as an identifier to a trained chatbot AI model 266. Once built, the service request 272 is delivered to the AI production system 230. Upon receipt of the service request 272, the AI production system 230 determines the target AI model, such as the trained chatbot AI model 266, and extracts the user prompt 270. In some examples and features of the instant solution, the AI production system transforms the user prompt 270 using Natural Language Understanding (NLU) or Natural Language Processing (NLP) techniques before delivering it to the trained chatbot AI model 266. Upon receipt of the possibly transformed user prompt 270, the trained chatbot AI model 266 determines an appropriate user response 274 and returns the user response 274 to the AI production system 230. In some examples and features of the instant solution, the trained chatbot AI model 266 utilizes neural networks or Natural Language Generation (NLG) techniques in order to determine the appropriate user response 274.

Upon receipt of the response, the AI production system 230 constructs and sends a service response 276 that contains the user response 274 back to the chatbot service 264. Upon receipt of the service response 276, the chatbot service 264 extracts the user response 274 and delivers it to the chatbot client 262, which emits it.

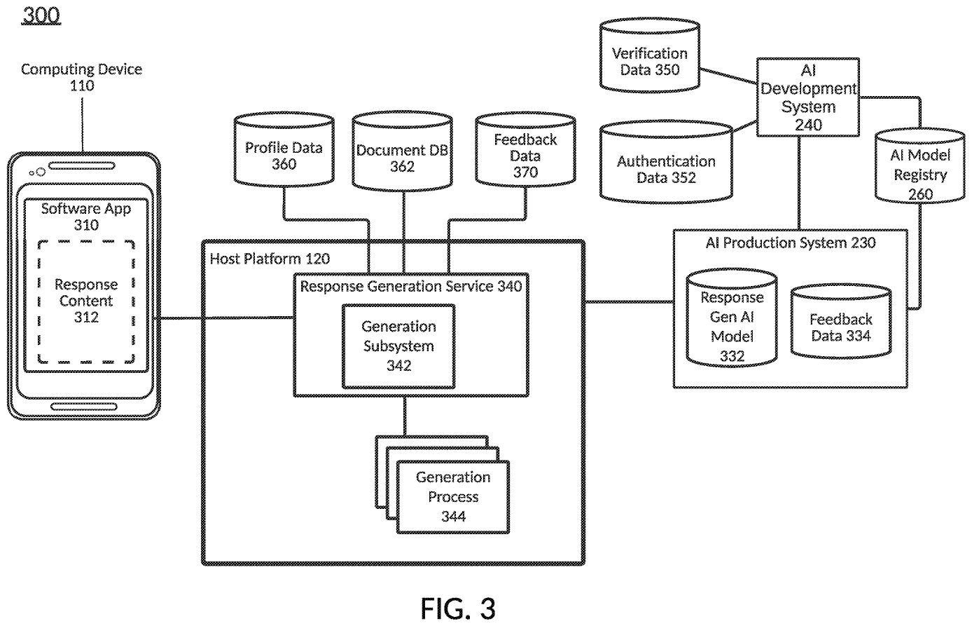

FIG. 3 illustrates an operating environment 300 for a RAG-based framework according to the examples and features of the instant solution.

In some examples and features of the instant solution, response generation AI model 332 is trained by executing the response generation AI model 332 on document content, text, descriptions, and the like, to generate a natural language response to a natural language query. The response generation AI model 332 is an example of AI model 232. In some embodiments, the training data may also include profile data from a profile database 360, model metadata from a document database 362, tests and/or training data used during development of AI models from a feedback database 370, and the like, are examples of data source 250.

In some examples and features of the instant solution, the response generation AI model 332 is trained using at least one neural network training method such as, but not limited to, gradient descent, stochastic gradient descent, random search, uniform search, basin hopping, and Krylov. In some examples and features of the instant solution, the response generation AI model 332 is a single or multi-layer perceptron neural network, a feed-forward neural network, a radial basis functional neural network, a recurrent neural network, or a modular neural network.

In some examples and features of the instant solution, the response generation AI model 332 may include, but is not limited to, at least one of a machine learning model, a deep learning model, a neural network, any combination of models from the branches of AI, and the like, and it may be trained using at least one of the respective training methods for machine learning models, deep learning models, neural networks, any combination of models from the branches of AI, and the like. In some examples and features of the instant solution, the training data may include, but is not limited to, at least one of the profile database 360, the document database 362, the feedback database 370, and the like. In some examples and features of the instant solution, the training data for the response generation AI model 332 may include, but is not limited to, internal data sources, external data sources, private data sources, public data sources, coding standards, or the like.

In some examples and features of the instant solution, the profile database 360 may store profiles for users including account data, passwords, usernames, payment card data, rights and restrictions, access rights to data, access rights to systems, and the like. In some examples and features of the instant solution, the document database 362 may include documents, manuals, files, web pages, word documents, journals, guidelines, frequently asked questions (FAQs), best practices, and the like. In some examples and features of the instant solution, the feedback database 370 may include feedback from users, systems, and the like, with respect to the responses generated by the response generation AI model 332, and the like.

The model feedback records in the model feedback data 334 may include, but is not limited to, inputs received from a user, source device, graphical user interface, etc., which include feedback on whether a retrieved AI model is approved by the user or the like.

Once the response generation AI model 332 is trained and validated, it is deployed to an AI production system 230 for use by a response generation service 340. The response generation service 340 is an example of software service 212.

In some examples and features of the instant solution, the software app 310, running on computing device 110, is an example of a service client. The software app 310 may include a chat application that enables a user of the computing device 110 to converse with a chatbot inside the software app 310. The responses that are output by the chatbot may be generated by the response generation service 340, including model content, test content, training data, and the like. In some embodiments, the software app 310 may also request additional data from the user of the computing device 110 when the response generation service 340 does not have enough data to provide a response, answer a question, etc. If these elements are not present, the system may ask the user a question in a natural language, for the missing data.

In some examples and features of the instant solution, the response generation service 340 receives data from the software app 310. The data may include, but is not limited to, input content input by a user into the software app 310 including typed content, spoken content captured by a microphone, and the like.

Additionally, the response generation service 340 receives data about the computing device 110. The device data may include, but is not limited to, the media access control (MAC) address and the source internet protocol (IP) address of the computing device.

The response generation service 340 may include a generation subsystem 342 that can receive data from a chat window and execute a generation process 344 on the data to retrieve vectors from a vector database (eg., the document database 362, etc.) and generate a response based on execution of the response generation AI model 332 on the query and the retrieved documents. The generation subsystem 342 is an example of decision subsystem 224. The generation process 344 generates a response (e.g., a natural language response) that is then output as response content 312 within a user interface of the software app 310.

In some examples and features of the instant solution, the response generation service 340 may continue to receive and process data from the software app 310 in parallel to the model retrieval process being performed.

The response generation AI model 332 may be part of the AI production system 230. Here, the response generation AI model 332 may be stored within an AI model registry 260 and may be trained and/or retrained by an AI development system 240, for example, based on training data, verification data 350, authentication data 352, and the like.

The system described herein may include logic for generating a natural language response to a natural language query. The system may include an AI model or a combination of AI models that are designed within a RAG architecture. During execution, a query is received, converted into a vector by a vectorizer, and then used to retrieve related document content from a vector storage. The AI model(s) then uses generative capabilities to generate a natural language response to the query based on the retrieved related document content. However, when the document content contains different levels of access (e.g., different user permissions to document data, etc.), there is a possibility that the AI model or AI models will generate a response that reveals sensitive data that the user is not authorized to view.

According to various embodiments, a retriever of the RAG architecture may use access credentials to reduce or redact vector/document content from a vector database prior to performing a retrieval process for response generation by the AI model. The retriever may identify a user/device associated with the query, identify access credentials assigned to the user or the device, and prevent vector content that the user does not have authorization to access from being ingested by the AI model during response generation by filtering out vectors or parts of vectors that contain sensitive document content that the user does not have authorization to view. By filtering the document content at the vector level, the AI model is prevented from leaking or otherwise revealing sensitive data (unauthorized data, etc.) with its answer.

For example, the system may receive a natural language query associated with a profile. The profile may be attached or otherwise embedded within a software application on a source device. Each time a new query comes to the host system, the system may detect an identifier of the profile that submitted the query. The system may determine access privileges of the profile to a database, such as a vector database which stores vectorized document content. The system may filter vectors/documents within the database to remove document content that does not match the access privileges. Furthermore, the system may the retrieve a subset of the filtered documents based on a comparison of the filtered documents to the natural language query in vector space. They system may generate a response to the natural language query based on the retrieved subset of filtered documents, and send the response to a software application.

In some embodiments, the database may include a vector database. The filtering may include filtering a group of vectors in the vector database containing document content based on the access privileges of the profile, and retrieving a subset of vectors from the filtered group of vectors in the vector database. The system may use a profile identifier or a device identifier to identify respective access privileges of the profile to the group of vectors within the vector database. The vectors themselves may include metadata that identifies which access credentials are required to obtain access to the vector content. The system may filter the group of vectors based on the identified respective access privileges to the group of vectors.

In some embodiments, the system may generate a prompt that includes the natural language query, the retrieved subset of filtered documents, and a task description, and executing an AI model on the prompt to generate the response. In some embodiments, the system may receive the natural language query from a chat window of the software application, and output the response through a chatbot within the chat window of the software application. In some embodiments, the system may redact a portion of document content that does not match the access privileges from a document, while also preserving another portion of document content from the document that does match the access privileges. The system may generate a response based on the partially-redacted document content within the document.

In some embodiments, the system may detect a selection by a user with respect to an input mechanism on a graphical user interface (GUI) of the software application, and in response, modify filtering settings of the software application to stop filtering the documents within the database for the profile. For example, the system may “turn off” or “turn on” the filtering based on access credentials in response to the user selection. Accordingly, when the system receives an additional natural language query associated with the profile, the system may retrieve an additional subset of documents from the documents within the database without filtering the documents, and generate a next response based on the additional subset of documents.

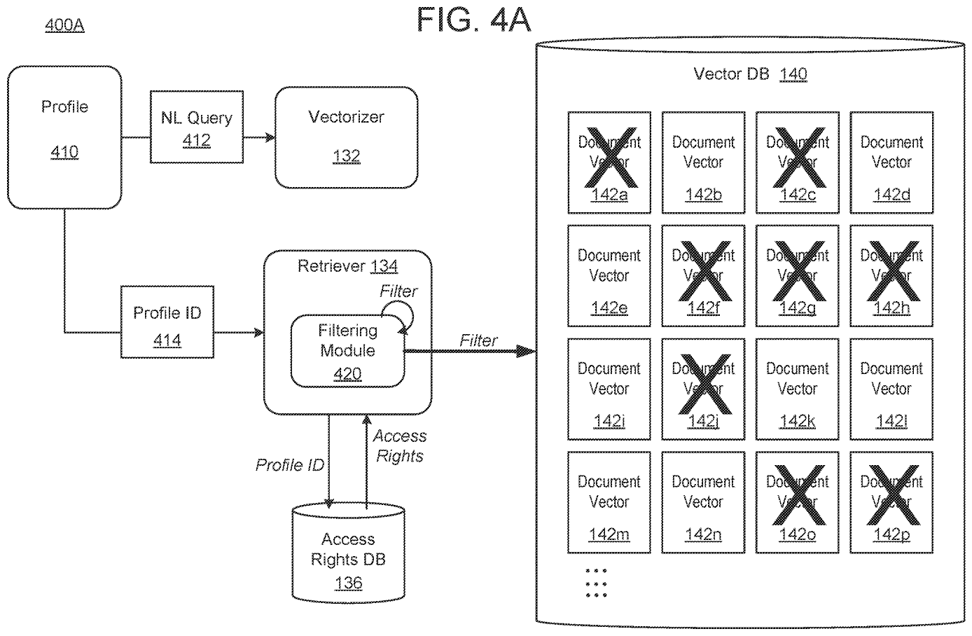

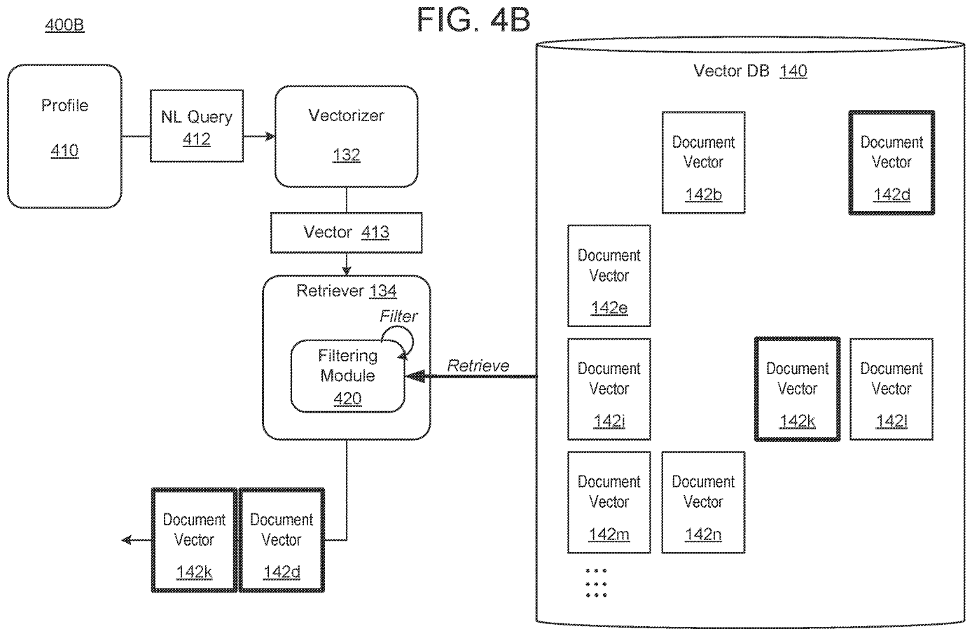

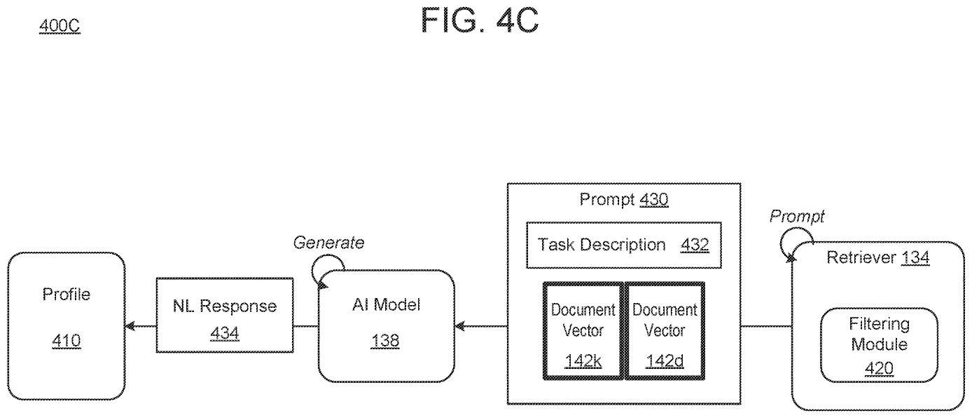

FIGS. 4A-4C illustrate a process of a RAG architecture that uses filters documents during retrieval based on access credentials according to the examples and features of the instant solution. For example, FIG. 4A illustrates a process 400A of filtering document content within a vector database 140 prior to performing a vector retrieval process according to the examples and features of the instant solution, FIG. 4B illustrates a retrieval process 400B by the retriever 134 on the filtered vectors within the vector database 140 according to the examples and features of the instant solution, and FIG. 4C illustrates a process 400C of generating a response based on the retrieved filtered vectors according to the examples and features of the instant solution.

Referring to FIG. 4A, a profile 410 (e.g., associated with a source device (not shown) may submit a natural language query 412 to the software service described herein. In this example, the natural language query 412 is received by the vectorizer 132. In addition, the profile 410 identifies a profile identifier 414 (e.g., device ID, user ID, IP address, MAC address, etc.) of the profile 410 and provides the profile identifier 414 to the retriever 134. Here, the retriever 134 uses the profile identifier 414 to look-up access credentials (e.g., user role, security clearance, pool, tier, etc.) and uses the access credentials to remove/filter out vectors with document content that the access credentials are not authorized to view/access.

For example, the retriever 134 may remove or otherwise prevent vectors 142a, 142c, 142f, 142g, 142h, 142j, 1420, and 142p from being ingested by the system, resulting in remaining vectors 142b, 142e, 142i, 142k, 1421, 142m, and 142n. The filtering process may be performed by a filtering module 420 that is integrated within the retriever 134 or otherwise in communication with the retriever 134. The filtering module 420 may be installed within the retriever 134 and/or the software service through a software update, a plugin, or the like.

Referring now to FIG. 4B, the vectorizer 132 may convert the natural language query 412 into a vector 413 that is transferred to the retriever 134. Here, after filtering the vectors within the vector database 140, the retriever 134 may perform a similarity search for the top n closest remaining vectors within the vector database 140, where n is a number that is at least one. The retriever 134 may retrieve a subset of vectors corresponding to the closest vectors to the vector 413 in vector space. Here, the direction of the vectors in the vector space may be used to identify how similar vectors are to each other. In this example, the retriever retrieves a vector 142k and a vector 142d from the remaining vectors 142b, 142e, 142i, 142k, 1421, 142m, and 142n. The retriever 134 may transfer the vector 142k and the vector 142d.

Referring now to FIG. 4C, the retriever 134 may generate a prompt 430 that includes the vector 142k and the vector 142d, along with static content such as a task description 432. The task description 432 may be part of a prompt template that is used by the retriever 134 to build the prompt 430. The prompt 430 may include machine-readable instructions. The retriever 134 transfers the prompt 430 to the AI model 138. In response, the AI model 138 generates a natural language response 434 based on execution of the AI model 138 on the prompt 430. The natural language response 434 is output to the profile 410, for example, a chat window in which the profile is currently viewing/watching, etc.

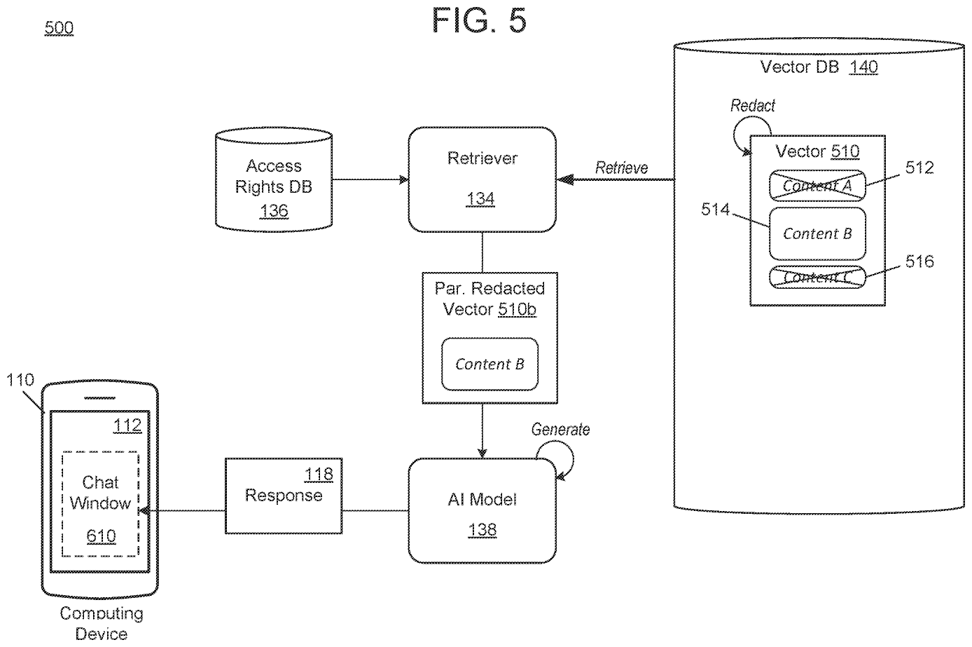

FIG. 5 illustrates a process 500 of partially redacting vector content according to the examples and features of the instant solution. Referring to FIG. 5, the vectors stored within the vector database 140 may contain multiple segments of vector content, where each segment may have its own respective access credential requirements than other segments of vector content in the same vector. The retriever 134 may receive the input and/or receive an identifier of the profile associated with the input. In response, the retriever 134 identifies the access privileges of the profile from the access rights database 136. The retriever 134 then uses the access privileges of the profile to redact content within the vector database 140.

In this example, the retriever 134 identifies a vector 510 within the vector database 140 that contains three segments of vector content including a vector segment 512, a vector segment 514, and a vector segment 516. In this example, the vector segment 514 contains restrictions that the profile is authorized to view. However, the vector segment 512 and the vector segment 516 contain restrictions that the profile is not authorized to view.

In this example, the retriever 134 (e.g., filtering module, etc.) may partially filter the vector content from the vector 510 to redact the vector segment 512 and the vector segment 516, while preserving the content of the vector segment 514. The result is a partially-redacted vector 510b. The partially-redacted vector 510b may be retrieved from the vector database 140 and input to the AI model 138 for response generation. Here, the AI model 138 may execute on the partially-redacted vector 510b to generate the response 118, and output the response to a chat window 610 within the GUI on the computing device 110.

In another example, the storage and retrieval capabilities of a vector database 140 are enhanced with access-controlled vectors by incorporating a secure file deduplication and redaction mechanism. This mechanism optimizes storage efficiency while maintaining strict access rights based on the access rights database 136 to ensure that document retrieval remains both secure and efficient. By leveraging partial redaction techniques, the instant solution reduces storage redundancy without compromising the integrity of document access control. The redaction mechanism employs a retriever 134 that identifies redundant vector content and selectively removes unauthorized segments while preserving accessible portions of a document.

When a document is uploaded into the vector database 140, it is first chunked into segments and transformed into vectors 510 using predefined conversion algorithms. Each vector is then assigned specific access permissions based on the originating document's sensitivity and user role classifications. Before storing the vector in the database, a retriever 134 applies a multi-stage redaction and similarity analysis, using cryptographic hashing and feature-based comparison to detect redundant vector content. Instead of simply eliminating identical vectors with differing access rights, the system partially redacts unauthorized segments within a vector 510b while preserving segments that match the user's permissions within the vector segment 514. This ensures that redundant vector storage is reduced while maintaining authorized access for all relevant users.

To enhance deduplication security, a hierarchical encryption technique prevents unauthorized users from deriving information from hashed or encrypted vectors. The retriever 134 processes vector content by first applying a lightweight hash-based pre-filtering step, followed by a deeper feature-matching analysis that considers vector characteristics, access history, and context-aware access permissions. If duplicate vectors are detected, the system merges access permissions and updates metadata to reflect the broader user access scope while maintaining strict compliance with role-based access controls utilizing the access rights database 136. The partially redacted vector 510b is then stored within the vector database 140, allowing optimized retrieval without compromising security.

This approach significantly reduces storage overhead and improves retrieval speed by minimizing redundant computations during vector-based queries. By redacting unauthorized content dynamically, the system ensures that sensitive information remains inaccessible while maintaining efficient data storage and retrieval capabilities. The retriever 134, in conjunction with chat window 610 services, facilitates controlled access to stored content, ensuring that users retrieve only permitted information while benefiting from enhanced storage optimization.

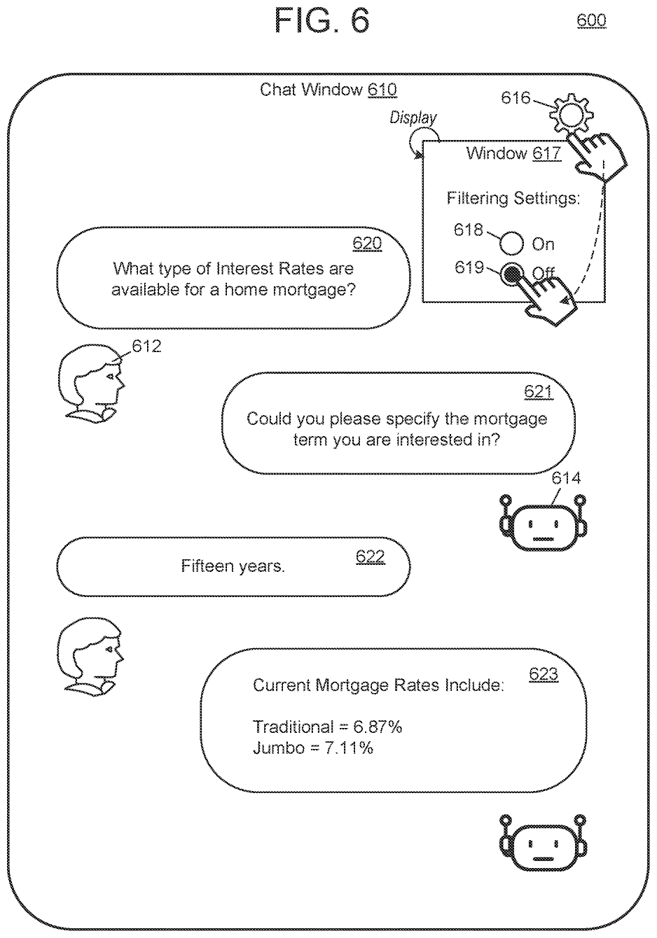

FIG. 6 illustrates a process 600 of modifying filtering settings of the retriever described herein according to the examples and features of the instant solution. Referring to FIG. 6, a chat conversation may be performed between the computing device 110 and the system described herein. The chat window 610 shown in FIG. 6 contains an example of a chat conversation between the computing device 110 and the host system. Here, the profile is associated with a user. The chat window 610 posts queries/inputs from the user along with an avatar 612 to identify that the user provides the input. Meanwhile, the chat window 610 also posts responses/outputs from the AI model through a chatbot 614 thereby identifying the response is from the system.

Here, the user posts a first natural language input 620 within the chat window 610, which includes a query for the chatbot 614. In response, the RAG system described herein identifies access credentials of the profile associated with the first natural language input 620, redacts document content from the vector database, and generates a response based on the redacted document content. Here, the RAG system determines that it does not have enough information to generate a response. Therefore, the system posts a response query 621 within the chat window 610 with a request for additional information. The user responds with a second natural language input 622 with the additional information requested by the system. In response, the system generates a natural language response 623 and outputs the natural language response 623 through the chatbot 614 within the chat window 610.

However, there may be a point in time when the user no longer wishes or needs the document content to be filtered. For example, if the user is asking more generalized questions, the system may not need to prevent sensitive data from being leaked, etc. In this case, the chat window 610 provides a settings button 616 which the user can click on with an input mechanism such as a touch, click, cursor, keyboard, etc. and open a window 617 with menu options for the filtering process. Here, the user may select a radio button 618 to cause the filtering to be performed and select a radio button 619 to cause the filtering not to be performed. In this case, the user presses the radio button 619 to prevent filtering. Therefore, the next time the user posts a natural language input, the system described herein can generate the response without filtering the vector content.

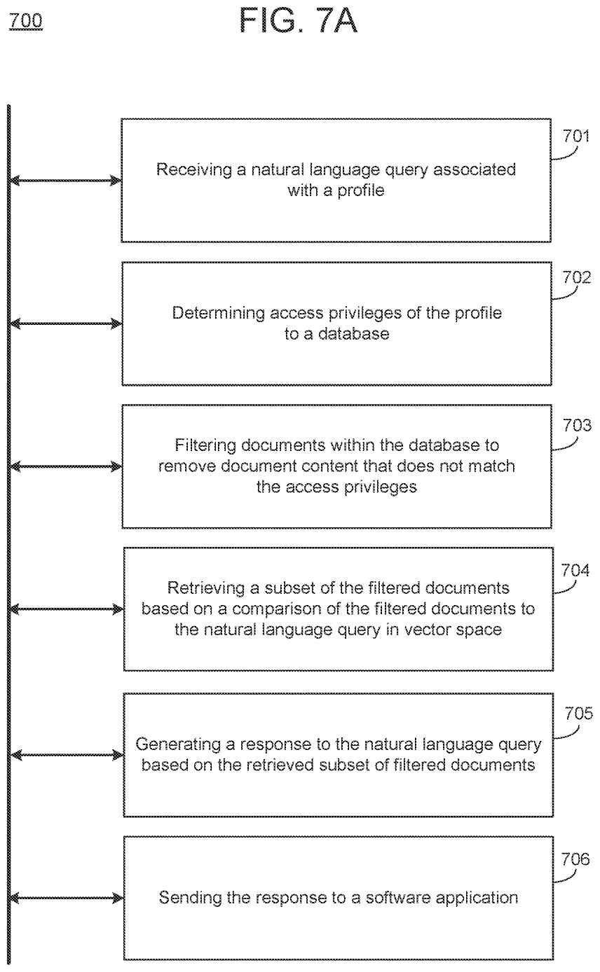

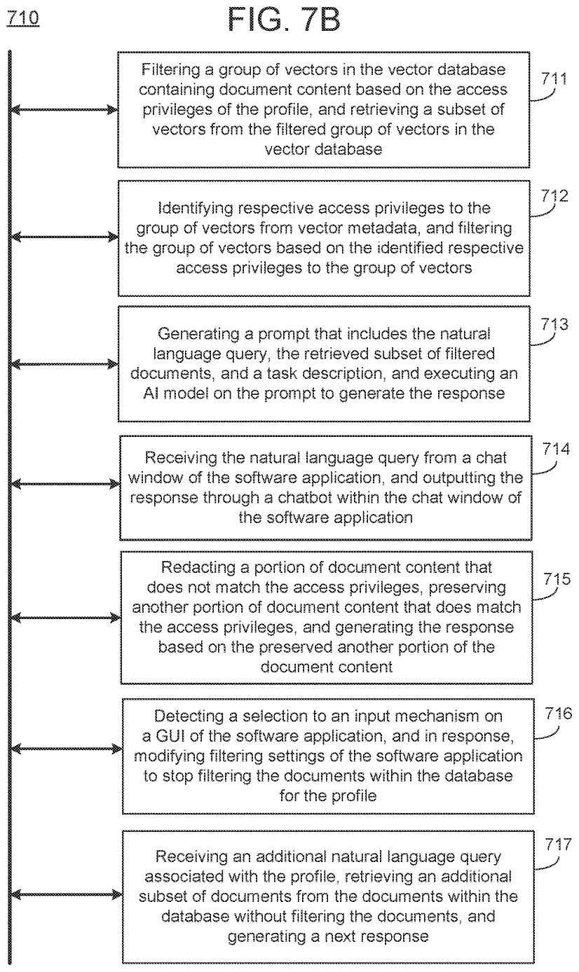

FIG. 7A illustrates a method 700 for recommending an AI model according to the examples and features of the instant solution. For example, the method 700 may be performed by a software application, a host platform, at least one processor, a storage device, and the like. Referring to FIG. 7A, in 701, the method may include receiving a natural language query associated with a profile. As another example, the input may be an input from a software application or other system that may not necessarily be in a natural language format, but may instead be in a machine-readable format or the like. In 702, the method may include determining access privileges of the profile to a database. In 703, the method may include filtering documents within the database to remove document content that does not match the access privileges. For example, the filtering may include filtering documents and portions of document content within a database to exclude from retrieval documents that do not match the determined access privileges. In 704, the method may include retrieving a subset of the filtered documents based on a comparison of the filtered documents to the natural language query in vector space. In 705, the method may include generating a response to the natural language query based on the retrieved subset of filtered documents. In 706, the method may include sending the response to a software application.

FIG. 7B illustrates an additional method 710 for recommending an AI model according to the examples and features of the instant solution. For example, the method 710 may be performed by a software application, a host platform, at least one processor, a storage device, and the like. Referring to FIG. 7B, in 711, the database includes a vector database, and the method includes filtering a group of vectors in the vector database containing document content based on the access privileges of the profile, and retrieving a subset of vectors from the filtered group of vectors in the vector database. In 712, the method may include identifying respective access privileges to the group of vectors from vector metadata, and filtering the group of vectors based on the identified respective access privileges to the group of vectors.

In 713, the method may include generating a prompt that includes the natural language query, the retrieved subset of filtered documents, and a task description, and executing an artificial intelligence (AI) model on the prompt to generate the response. In 714, the method may include receiving the natural language query from a chat window of the software application, and the sending comprises outputting the response through a chatbot within the chat window of the software application. In 715, the method may include redacting a portion of document content that does not match the access privileges from a document, preserving another portion of document content from the document that does match the access privileges, and generating the response based on the preserved another portion of the document content.

In 716, the method may include detecting a selection to an input mechanism on a graphical user interface (GUI) of the software application, and in response, modifying filtering settings of the software application to stop filtering the documents within the database for the profile. In 717, the method may include receiving an additional natural language query associated with the profile, retrieving an additional subset of documents from the documents within the database without filtering the documents, and generating a next response based on the additional subset of documents.

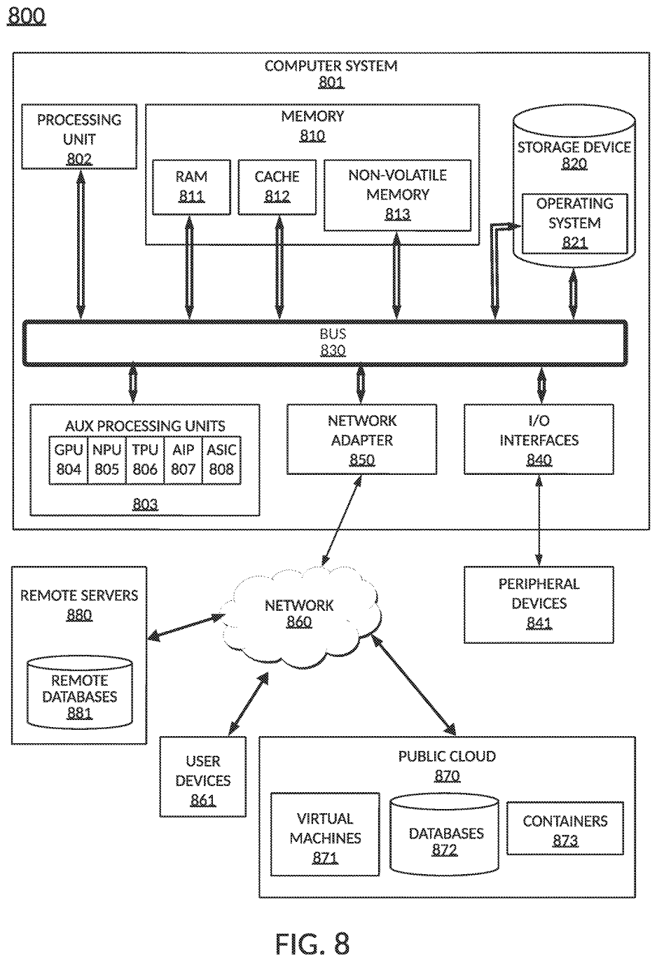

The examples and features of the instant solution may be implemented in at least one of the elements described or depicted herein, including for example, the elements described or depicted in FIG. 8. These examples and features may further be implemented in hardware, in a computer program executed by a processor, in firmware, or in a combination of the above. A computer program may be embodied on a computer readable medium, such as a storage medium. For example, a computer program may reside in random access memory (RAM) , flash memory, read-only memory (ROM) , erasable programmable read-only memory (EPROM), electrically erasable programmable read-only memory (EEPROM) , registers, hard disk, a removable disk, a compact disk read-only memory (CD-ROM) , or any other form of storage medium known in the art.

A n exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 8 illustrates an example computer system architecture, which may represent or be integrated in any of the above-described components, etc.

FIG. 8 illustrates a computing environment according to the instant solution's example features, structures, or characteristics. FIG. 8 is not intended to suggest any limitation as to the scope of use or functionality of features, structures, or characteristics of the instant solution of the application described herein. Regardless, the computing environment 800 can be implemented to perform any of the functionalities described herein. In computing environment 800, there is a computer system 801, operational within numerous other general-purpose or special-purpose computing system environments or configurations.

Computer system 801 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 860 or querying a database. Depending upon the technology, the performance of a computer-implemented method may be distributed among multiple computers and among multiple locations. However, in this presentation of the computing environment 800, a detailed discussion is focused on a single computer, specifically computer system 801, to keep the presentation as simple as possible.

Computer system 801 may be located in a cloud, even though it is not shown in a cloud in FIG. 8. On the other hand, computer system 801 may not be in a cloud except to any extent as may be affirmatively indicated. Computer system 801 may be described in the general context of computer system-executable instructions, such as program modules, executed by a computer system 801. Generally, program modules may include routines, programs, objects, components, logic, data structures, and so on that perform tasks or implement certain abstract data types. As shown in FIG. 8, computer system 801 in computing environment 800 is shown in the form of a general-purpose computing device. The components of computer system 801 may include but are not limited to, at least one processor or processing unit 802, a system memory 810, and a bus 830 that couples various system components, including system memory 810 to processing unit 802.

Processing unit 802 includes at least one computer processor of any type now known or to be developed. The processing unit 802 may contain circuitry distributed over multiple integrated circuit chips. The processing unit 802 may also implement multiple processor threads and multiple processor cores. Cache 812 is a memory that may be in the processor chip package(s) or located “off-chip,” as depicted in FIG. 8. Cache 812 is typically used for data or code accessed by the threads or cores running on the processing unit 802. In some computing environments, processing unit 802 may be designed to work with qubits and perform quantum computing.

The Auxiliary Processing Units (A PU) 803 may contain at least one Graphics Processing Unit (GPU) 804, Neural Processing Unit (NPU) 805, Tensor Processing Unit (TPU) 806, AI Processor (AIP) 807, or other Application Specific Integrated Circuit (A SIC) 808. The at least one A PU 803 may contain circuitry distributed over multiple integrated circuit chips. Each A PU 803 may implement multiple processor threads and multiple processor cores. Each APU 803 may include at least one of onboard memory, onboard memory cache, and onboard instruction cache. Each A PU may be communicatively coupled to the system bus 830 and configure to communicate with other system components, including a processing unit 802, system cache 812, RAM 811, non-volatile RAM 813, operating system 821, Network adapter 850, and Input/Output interfaces 840. In some computing environments, at least one of the at least one A PU 803 may be designed to work with qubits and perform quantum computing.

M emory 810 is any volatile memory now known or to be developed in the future. Examples include dynamic random-access memory (RAM) 811 or static type RAM 811. Typically, the volatile memory is characterized by random access, but this may not be the characterization unless affirmatively indicated. In computer system 801, memory 810 is in a single package. It is internal to computer system 801, but alternatively or additionally, the volatile memory may be distributed over multiple packages and/or located externally with respect to computer system 801. By way of example, memory 810 can be provided for reading from and writing to a non-removable, non-volatile magnetic media (shown as storage device 820, and typically called a “hard drive”). Memory 810 may include at least one program product having a set (e.g., at least one) of program modules configured to carry out the functions of various features, structures, or characteristics of the instant solution of the application. A typical computer system 801 may include cache 812, a specialized volatile memory generally faster than RAM 811 and generally located closer to the processing unit 802. Cache 812 stores frequently accessed data and instructions accessed by the processing unit 802 to speed up processing time. The computer system 801 may also include non-volatile memory 813 in the form of ROM, PROM, EEPROM, and flash memory. Non-volatile memory 813 often contains programming instructions for starting the computer, including the basic input/output system (BIOS) and information to start the operating system 821.

Computer system 801 may include a removable/non-removable, volatile/non-volatile computer storage device 820. For example, storage device 820 can be a non-removable, non-volatile magnetic media (not shown and typically called a “hard drive”). At least one data interface can connect it to the bus 830. In features, structures, or characteristics of the instant solution where computer system 801 has a large amount of storage (for example, where computer system 801 locally stores and manages a large database), then this storage may be provided by peripheral storage devices 820 designed for storing very large amounts of data, such as a storage area network (SAN) that is shared by multiple, geographically distributed computers.

The operating system 821 is software that manages computer system 801 hardware resources and provides common services for computer programs. Operating system 821 may take several forms, such as various known proprietary operating systems or open-source Portable Operating System Interface type operating systems that employ a kernel.

The bus 830 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (M CA) buses, Enhanced ISA (EISA) buses, Video Electronics Standards Association (VESA) local buses, and Peripheral Component Interconnect (PCI) bus. The bus 830 is the signal conduction path that allows the various components of computer system 801 to communicate.

Computer system 801 may communicate with at least one peripheral device, 841, via an input/output (I/O) interface, 840. Such devices may include a keyboard, a pointing device, a display, etc. ; at least one device that enables a user to interact with computer system 801; and/or any devices (e.g., network card, modem, etc.) that enable computer system 801 to communicate with at least one other computing devices. Such communication can occur via I/O interface 840. As depicted, I/O interface 840 communicates with the other components of computer system 801 via bus 830.

Network adapter 850 enables the computer system 801 to connect and communicate with at least one network 860, such as a local area network (LAN) , a wide area network (WAN), and/or a public network (e.g., the Internet). It bridges the computer's internal bus 830 and the external network, exchanging data efficiently and reliably. The network adapter 850 may include hardware, such as modems or Wi-Fi signal transceivers, and software for packetizing and/or de-packetizing data for communication network transmission. Network adapter 850 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 860 is any computer network that can receive and/or transmit data. Network 860 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 860 may be replaced and/or supplemented by LA Ns designed to communicate data between devices in a local area, such as a Wi-Fi network. The network 860 typically includes computer hardware such as copper transmission cables, optical transmission fibers, wireless transmission, routers, firewalls, switches, gateway computers, edge servers, and network infrastructure known now or to be developed in the future. Computer system 801 connects to network 860 via network adapter 850 and bus 830.

User devices 861 are any computer systems used and controlled by an end user in connection with computer system 801. For example, in a hypothetical case where computer system 801 is designed to provide a recommendation to an end user, this recommendation may typically be communicated from network adapter 850 of computer system 801 through network 860 to a user device 861, allowing user device 861 to display, or otherwise present, the recommendation to an end user. U ser devices can be a wide array, including personal computers, laptops, tablets, hand-held, mobile phones, etc.

A public cloud 870 is an on-demand availability of computer system resources, including data storage and computing power, without direct active management by the user. Public clouds 870 are often distributed, with data centers in multiple locations for availability and performance. Computing resources on public clouds 870 are shared across multiple tenants through virtual computing environments comprising virtual machines 871, databases 872, containers 873, and other resources. A container 873 is an isolated, lightweight software for running a software application on the host operating system 821. Containers 873 are built on top of the host operating system's kernel and contain software applications and some lightweight operating system A Pls and services. In contrast, virtual machine 871 is a software layer with an operating system 821 and kernel. Virtual machines 871 are built on top of a hypervisor emulation layer designed to abstract a host computer's hardware from the operating software environment. Public clouds 870 generally offers databases 872, abstracting high-level database management activities. At least one element described or depicted in FIG. 8 can perform at least one of the actions, functionalities, or features described or depicted herein.

Remote servers 880 are any computers that serve at least some data and/or functionality over a network 860, for example, WAN, a virtual private network (VPN), a private cloud, or via the Internet to computer system 801. These networks 860 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 880 can also host remote databases 881, with the database located on one remote server 880 or distributed across multiple remote servers 880. Remote databases 881 are accessible from database client applications installed locally on the remote server 880, other remote servers 880, user devices 861, or computer system 801 across a network 860. An AI/ML model described or depicted here may reside fully or partially on any of the elements described or depicted in FIG. 8.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by at least one of the modules or components described herein or in a distributed architecture and may include a transmitter, receiver, or pair of both. For example, all or part of the functionality performed by the individual modules may be performed by at least one of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via at least one of the other modules.

One skilled in the art will appreciate that the instant solution may be embodied as a personal computer, a server, a console, a personal digital assistant (PDA) , a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms consistent with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise at least one physical or logical block of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution are not intended to limit the scope of the instant solution as claimed but are merely representative examples of the instant solution.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

While preferred examples of the present instant solution have been described, it is to be understood that the examples described are illustrative only, and the scope of the instant solution is to be defined solely by the appended claims when considered with a full range of equivalents and modifications (e.g., protocols, hardware devices, software platforms, etc.) thereto.

1. An apparatus comprising:
a memory; and
at least one processor which is communicably coupled to the memory, wherein the at least one processor is configured to:
receive a natural language query associated with a profile;
determine access privileges of the profile to a database;
filter documents within the database to remove document content that does not match the access privileges and generate a filtered set of documents;
retrieve a subset of documents from the filtered set of documents based on a comparison of the filtered set of documents to the natural language query in vector space;
generate a response to the natural language query based on the retrieved subset of documents; and
send the response to a software application.

2. The apparatus of claim 1, wherein the database comprises a vector database and the at least one processor is configured to filter a group of vectors in the vector database containing vectorized document content based on the access privileges of the profile, and retrieve a subset of vectors from the filtered group of vectors in the vector database.

3. The apparatus of claim 2, wherein the at least one processor is configured to identify respective access privileges to the group of vectors from vector metadata, and filter the group of vectors based on the identified respective access privileges to the group of vectors.

4. The apparatus of claim 1, wherein the at least one processor is configured to generate a prompt that includes the natural language query, the retrieved subset of documents, and a task description, and execute an artificial intelligence (AI) model on the prompt to generate the response.

5. The apparatus of claim 1, wherein the at least one processor is configured to receive the natural language query from a chat window of the software application, and output the response through a chatbot within the chat window of the software application wherein an AI agent performs an action related to the response.

6. The apparatus of claim 1, wherein the at least one processor is configured to redact a portion of document content that does not match the access privileges from a document, preserve another portion of document content from the document that does match the access privileges, and generate the response based on the preserved another portion of the document content.

7. The apparatus of claim 1, wherein the at least one processor is further configured to detect a selection to an input mechanism on a graphical user interface (GUI) of the software application, and in response, modify filtering settings of the software application to stop filtering the documents within the database for the profile.

8. (canceled)

9. A method comprising:
receiving a natural language query associated with a profile;
determining access privileges of the profile to a database;
filtering documents within the database to remove document content that does not match the access privileges and generate a filtered set of documents;
retrieving a subset of documents from the filtered set of documents based on a comparison of the filtered set of documents to the natural language query in vector space;
generating a response to the natural language query based on the retrieved subset of documents; and
sending the response to a software application.

10. The method of claim 9, wherein the database comprises a vector database, the filtering comprises filtering a group of vectors in the vector database containing vectorized document content based on the access privileges of the profile, and the retrieving comprises retrieving a subset of vectors from the filtered group of vectors in the vector database.

11. The method of claim 10, wherein the filtering the group of vectors comprises identifying respective access privileges to the group of vectors from vector metadata, and filtering the group of vectors based on the identified respective access privileges to the group of vectors.

12. The method of claim 9, wherein the generating comprises generating a prompt that includes the natural language query, the retrieved subset of documents, and a task description, and executing an artificial intelligence (AI) model on the prompt to generate the response.

13. The method of claim 9, wherein the receiving comprises receiving the natural language query from a chat window of the software application, and the sending comprises outputting the response through a chatbot within the chat window of the software application wherein an AI agent performs an action related to the response.

14. The method of claim 9, wherein the filtering comprises redacting a portion of document content that does not match the access privileges from a document, preserving another portion of document content from the document that does match the access privileges, and generating the response based on the preserved another portion of the document content.

15. (canceled)

16. The method of claim 9, further comprising receiving an additional natural language query associated with the profile, retrieving an additional subset of documents from the documents within the database without filtering the documents, and generating a next response based on the additional subset of documents.

17. A computer-readable storage medium comprising instructions which when executed by a processor cause the processor to perform:
receiving a natural language query associated with a profile;
determining access privileges of the profile to a database;
filtering documents within the database to remove document content that does not match the access privileges and generate a filtered set of documents;
retrieving a subset of documents from the filtered set of documents based on a comparison of the filtered set of documents to the natural language query in vector space;
generating a response to the natural language query based on the retrieved subset of documents; and
sending the response to a software application.

18. The computer-readable storage medium of claim 17, wherein the database comprises a vector database, the filtering comprises filtering a group of vectors in the vector database containing vectorized document content based on the access privileges of the profile, and the retrieving comprises retrieving a subset of vectors from the filtered group of vectors in the vector database.

19. The computer-readable storage medium of claim 18, wherein the filtering the group of vectors comprises identifying respective access privileges to the group of vectors from vector metadata, and filtering the group of vectors based on the identified respective access privileges to the group of vectors.

20. The computer-readable storage medium of claim 17, wherein the generating comprises generating a prompt that includes the natural language query, the retrieved subset of filtered documents, and a task description, and executing an artificial intelligence (AI) model on the prompt to generate the response.

21. The apparatus of claim 1, wherein the at least one processor generates the filtered set of documents after receipt of the query and prior to performance of the comparison in vectors space.

22. The apparatus of claim 1, wherein the at least one processor is configured to prompt a response generating artificial intelligence (AI) model, prior to generation of the response, to restrict generation of the response to content derived from the filtered set of documents.
